(19) United States
(12) Patent Application Publication
(10) Pub. No.: US 2025/0234088 A1
(43) Pub. Date: Jul. 17, 2025

(54) CAMERA, METHOD FOR PROLONGING BATTERY USAGE LIFE OF CAMERA, AND COMPUTER-READABLE STORAGE MEDIUM

(71) Applicant: Shenzhen Reolink Technology Co., Ltd., Shenzhen (CN)

(72) Inventors: Haohui Xu, Shenzhen (CN); Jiuming Li, Shenzhen (CN)

(21) Appl. No.: 19/096,895

(22) Filed: Apr. 1, 2025

(30) Foreign Application Priority Data
Apr. 10, 2024 (CN) 202410444938.6

(51) Int. Cl. H04N 23/65; H04N 23/56; H04N 23/63

(52) U.S. Cl. CPC H04N 23/651; H04N 23/56; H04N 23/631

(57) ABSTRACT

The present application provides a method for prolonging battery usage life of a camera. The method includes acquiring an electric quantity value S of the camera; determining a magnitude relationship between the electric quantity value S and a first threshold S₁ and a second threshold S₂, where S₂>S₁>0. The camera is controlled to work in a high-electric quantity mode if S≥S₂, and a power at which the camera operates in the high-electric quantity mode is P₁. The camera is controlled to work in a medium-electric quantity mode if S₁≤S<S₂, and a power at which the camera operates in the medium-electric quantity mode is P₂. The camera is controlled to work in a low-electric quantity mode if S<S₁, and a power at which the camera operates in the low-electric quantity mode is P₃, where P₁>P₂>P₃.

### TECHNICAL FIELD

This application relates to the technical field of security video recording monitoring, and particularly relates to a camera, a method for prolonging battery usage life of a camera, and a non-transitory computer-readable storage medium.

### BACKGROUND

With the development of Internet of Things (IoT) technology and image processing technology, cameras are widely used in a variety of security monitoring systems. The video recording of monitored areas by the cameras is a core component of the security monitoring systems, which not only provides real-time monitoring and post-event investigation capabilities but also offers deeper support for security management through intelligent analysis. A long-powered camera is connected to a power grid via a cable to achieve power supply, does not need to frequently replace the power supply or battery, battery life time is not limited, can operate stably for a long time, and can meet the requirements of long battery usage life of the camera in the security monitoring system. However, since an external stable power supply is required to continuously supply an operating power to the long-powered camera during its operation, there is a high requirement for an external environment, which makes it impossible to use such a camera in some occasions. In a case where a stable power supply cannot be provided, a camera equipped with a battery is generally used, and the battery is used to provide an operating power supply for the camera.

In order to meet the requirements of uninterrupted operation of the security monitoring system and in consideration of various complex situations in practical application, the camera is required to have a certain capability of enduring battery life. For a camera using a battery to provide an operating power supply, if the camera is continuously in a high-power video recording state, there is a case where power consumption of the camera is too fast, resulting in a short battery life time of the camera. If a large-capacity battery is provided for the camera to increase the battery life time of the camera, the hardware improvement of the camera is involved and the cost is high in this way. It is a problem to be solved how to prolong the battery usage life time of the camera without improving the hardware of the camera, that is, without replacing or upgrading the battery of the camera.

### SUMMARY

In view of the above-mentioned problems, the embodiments of the present application provide a camera, a method for prolonging battery usage life of a camera, and a computer-readable storage medium, which can solve the problem existing in the prior art that the battery usage life time of a camera needs to be prolonged.

According to one aspect of an embodiment of the present application, a method for prolonging battery usage life of a camera, the method including: acquiring an electric quantity value of the camera; determining a magnitude relationship between the electric quantity value and a first threshold, and the magnitude relationship between the electric quantity value and a second threshold, wherein the second threshold is greater than the first threshold; controlling the camera to work in a high-electric quantity mode if the electric quantity value is greater than or equal to the second threshold, and a power at which the camera operates in the high-electric quantity mode to be a first power; controlling the camera to work in a medium-electric quantity mode if the electric quantity value is greater than or equal to the first threshold but less than the second threshold, and a power at which the camera operates in the medium-electric quantity mode to be a second power; and controlling the camera to work in a low-electric quantity mode if the electric quantity value is less than the first threshold, and a power at which the camera operates in the low-electric quantity mode to be a third power; wherein the first power is greater, and the second power is greater than the third power.

In an alternative, the method further includes: generating a video recording interface and displaying same on an electronic device, wherein the electronic device is communicatively connected to the camera; displaying a first icon for setting the first threshold and a second icon for setting the second threshold on the video recording interface, wherein the first icon and the second icon are used for sliding in a preset area, and different positions of the first icon and the second icon in the preset area correspond to different electric quantity values; and displaying one first text corresponding to the first icon and one second text corresponding to the second icon on the video recording interface, wherein the contents displayed by the first text and the second text are respectively electric quantity values corresponding to positions where the first icon and the second icon are located.

In an alternative, the method further includes: acquiring a first electric quantity value corresponding to the position where the first icon is located in the preset area; storing the first electric quantity value as the first threshold in a memory of the camera; acquiring a second electric quantity value corresponding to the position where the second icon is located in the preset area; and storing the second electric quantity value as the second threshold in the memory of the camera.

In an alternative, the first icon is displayed in a first color and the second icon is displayed in a second color.

In an alternative, the camera includes an image capture unit and a fill light, a maximum video recording frame rate of the image capture unit is Fₘₐₓ, and a maximum luminous power of the fill light is Wₘₐₓ, and the method further includes: when the mode of the camera is the high-electric quantity mode, adjusting the luminous power of the fill light to a first power W₁, and controlling the image capture unit to perform video recording at a first video recording frame rate F₁, where 0<F₁≤Fₘₐₓ, and 0<W₁≤Wₘₐₓ.

In an alternative, the method further includes: when the mode of the camera is the medium-electric quantity mode, adjusting the luminous power of the fill light to a second power W₂, and controlling the image capture unit to perform video recording at a second video recording frame rate F₂, where 0<F₂<F₁ and 0<W₂<W₁.

In an optional aspect, the camera further includes a sensing unit, and the method further includes: when the mode of the camera is the medium-electric quantity mode, in response to the sensing unit detecting presence of an intruding target in a monitored area, adjusting the luminous power of the fill light to a third power W₃, and controlling the image capture unit to perform video recording at a third video recording frame rate F₃, where 0<F₂<F₃≤Fₘₐₓ, and 0<W₂<W₃≤Wₘₐₓ; in response to an operation of previewing the recorded video, adjusting the luminous power of the fill light to the third power W₃, and controlling the image capture unit to perform video recording at the third video recording frame rate F₃; and in response to the sensing unit detecting the intruding target leaving the monitored area, or ending the operation of previewing the recorded video, controlling the mode of the camera to switch back to the medium-electric quantity mode.

In an alternative, the camera includes an image capture unit, a fill light and a sensing unit, a maximum video recording frame rate of the image capture unit is Fₘₐₓ, and a maximum luminous power of an infrared lamp is Wₘₐₓ, and the method further includes: controlling the camera to enter a standby state when the mode of the camera is the low-electric quantity mode, where the sensing unit is in an operating state when the camera is in the standby state; when the camera is in the standby state, in response to the sensing unit detecting the presence of the intruding target in the monitored area, adjusting the luminous power of the fill light to a third power W₃, and controlling the image capture unit to perform video recording at a third video recording frame rate F₃, where 0<F₃≤Fₘₐₓ, and 0<W₃≤Wₘₐₓ; in response to an operation of previewing the recorded video, adjusting the luminous power of the fill light to the third power W₃, and controlling the image capture unit to perform video recording at the third video recording frame rate F₃; and in response to the sensing unit detecting that the intruding target leaves the monitoring area, or ending the operation of previewing the recorded video, controlling the operating state of the camera to switch back to the standby state.

In an alternative, the camera further includes an AI detection unit, and the method further includes: in response to the sensing unit detecting the presence of the intruding target in the monitored area, controlling the AI detection unit to acquire a current image acquired at a current time of the image capture unit, and performing intruding target identification on the current image; and if the AI detection unit identifies the intruding target from the current image, adjusting the luminous power of the fill light to the third power W₃, and controlling the image capture unit to perform video recording at the third video recording frame rate F₃.

In an alternative, the camera further includes an AI detection unit, and the method further includes: controlling an AI detection unit of the camera to parse the video recorded by the camera if the electric quantity value is greater than or equal to the second threshold; and turning off the AI detection unit if the electric quantity value is less than the second threshold.

In an alternative, before the acquiring the current electric quantity value S of the camera, the method further includes: determining whether the current time is within a preset timed video recording period; if the current time is within the timed video recording period, determining whether the camera is configured in a power-saving mode; if the camera is configured in the power-saving mode, proceeding to the step of acquiring the current electric quantity value S of the camera; if the camera is not configured in the power-saving mode, adjusting the luminous power of the fill light of the camera to the maximum luminous power Wₘₐₓ, and controlling the image capture unit of the camera to perform video recording at the maximum video recording frame rate Fₘₐₓ; if the current time is not within the timed video recording period, controlling the camera to enter the standby state; when the camera is in the standby state, in response to the sensing unit of the camera detecting the presence of an intruding target or previewing the recorded video in a monitored area, adjusting the luminous power of the fill light to the third power W₃, and controlling the image capture unit to perform video recording at the third video recording frame rate F₃, where 0<F₃≤Fₘₐₓ, and 0<W₃≤Wₘₐₓ; and controlling the camera to enter the standby state in response to the sensing unit detecting the intruding target leaving the monitored area, or ending the operation of previewing the recorded video.

According to a second aspect of an embodiment of the present application, a camera is provided, which includes: a memory and at least one processor; where the memory stores computer-executed instructions; and the at least one processor executes the computer-executed instructions stored in the memory to cause the at least one processor to perform the operation of the method for prolonging battery usage life of a camera as described above.

According to a third aspect of the embodiment of the present application, a computer-readable storage medium is provided, where the computer-readable storage medium has stored thereon executable instructions which, when executed, perform the method for prolonging battery usage life of a camera as described above.

In the embodiment of the present application, the camera is controlled to work in a camera shooting mode according to a current electric quantity value S of the camera, so that the camera operates in the camera mode; if the current electric quantity value S belongs to different electric quantity intervals, the modes corresponding to the electric quantity value S are also different, and when the camera is operated in different camera shooting modes, the power and the power consumption are also different. When the current electric quantity value S is small, the camera is operated in the determined mode in which the power consumption is also low, so that the battery usage life time of the camera is prolonged as compared with the case where the camera is always operated in a single mode in which the power consumption is high.

In the present application, insofar as the improvement of the hardware of the camera is not involved, in order to improve the battery life time of the camera, the present application proposes a method for prolonging battery usage life of a camera, where a current electric quantity value of the camera is acquired, and a camera shooting mode of the camera is determined according to the current electric quantity value, so as to control the camera to operate in a corresponding shooting mode. When the current electric quantity value is small, the power of the camera in the corresponding target mode is also small, so that the camera is not continuously in a high-power operating state, thereby prolonging the battery usage life time of the camera.

### BRIEF DESCRIPTION OF THE DRAWINGS

The drawings are only for purposes of illustrating the embodiments and are not to be construed as limiting the present application. Moreover, like reference numerals designate like parts throughout the several views. In the drawings:

FIG. 1 is a schematic diagram showing an application scenario according to an embodiment of the present application;

FIG. 2 is a schematic flow chart showing a camera according to an embodiment of the present application;

FIG. 3 is a schematic flow chart showing a method for prolonging battery usage life of a camera according to an embodiment of the present application;

FIG. 4 is a schematic flow chart showing a method for setting a first threshold and a second threshold according to an embodiment of the present application;

FIG. 5 is a schematic diagram showing an intelligent video recording setting interface displayed on an electronic device according to an embodiment of the present application;

FIG. 6 is a schematic flow chart showing a method for prolonging battery usage life of a camera according to another embodiment of the present application; and

FIG. 7 is a schematic flow chart showing a method for prolonging battery usage life of a camera according to another embodiment of the present application.

### DETAILED DESCRIPTION

Exemplary embodiments of the present application will be described in more detail below referring to the accompanying drawings. While the drawings show exemplary embodiments of the present application, the present application may be embodied in various forms and should not be construed as limited to the embodiments set forth herein.

FIG. 1 is a schematic diagram showing an application scenario for a method for prolonging battery usage life of a camera according to an embodiment of the present application. As shown in FIG. 1, the camera 1 establishes a communication connection with an electronic device 2 via a network 3. The camera 1 may be a battery powered camera for security monitoring, a battery powered photographic device, or other video recording monitoring apparatus powered by batteries. The electronic device 2 can be a touch-control type mobile phone, an intelligent mobile phone, a tablet computer, a portable electronic device or other terminal electronic devices with a display screen. The network 3 includes, but is not limited to, one or more of a local area network (LAN), a metropolitan area network (MAN), a wide area network (WAN), a 4G or 5G network, a WIFI, a Bluetooth, or other communication networks.

In an embodiment of the present application, the camera 1 and the electronic device 2 may each include one or more processors, which may be a central processing unit CPU, or an Application Specific Integrated Circuit (ASIC), or one or more integrated circuits configured to implement the embodiment, which is not limited herein. The electronic device may include one or more processors, which may be of the same type, such as one or more CPUs; it may also be a different type of processor, such as one or more CPUs and one or more ASICs, which is not limited herein.

In the embodiment of the present application, the camera 1 is installed in an area to be monitored (e.g., home, office, shopping mall, etc.), so that the camera 1 can continuously take a monitoring video recording in the monitored area and transmit the captured video recording to the electronic device 2 of the terminal via the network 3 for the user to browse.

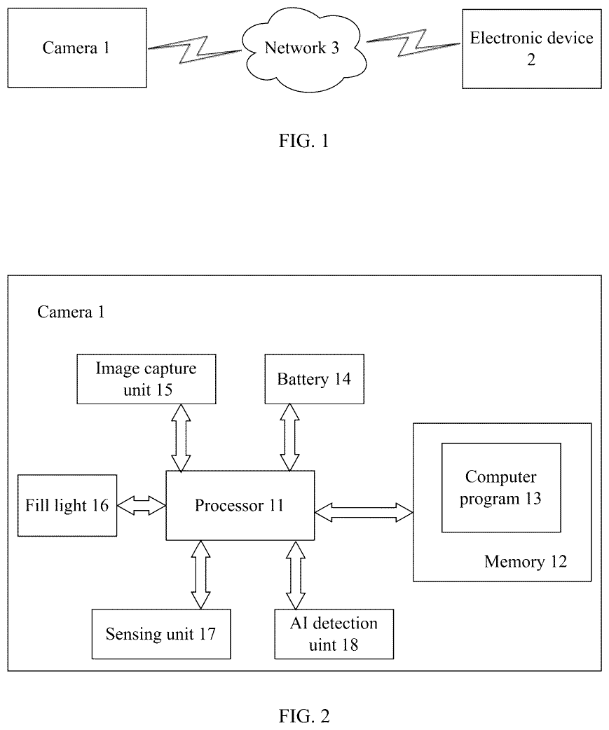

FIG. 2 is a schematic structural diagram showing a camera according to an embodiment of the present application. As shown in FIG. 2, the camera 1 may include at least one processor 11 and a memory 12.

The processor 11 is configured to execute a computer program 13, and specifically can execute relevant steps in the embodiment of the method for prolonging battery usage life of a camera provided in the present application. Specifically, the computer program 13 may include a plurality of computer-executable instructions.

The processor 11 may be a central processing unit CPU, or an Application Specific Integrated Circuit (ASIC), or one or more integrated circuits configured to implement the embodiments of the present application. The camera 1 may include one or more processors, which may be of the same type, such as one or more CPUs; it may also be a different type of processor, such as one or more CPUs and one or more ASICS.

The memory 12 is coupled to the at least one processor 11 and configured to store the computer program 13. The memory 12 may include high-speed RAM memory, and may also include non-volatile memory, such as at least one disk memory.

In the embodiment of the present application, the camera 1 further includes a battery 14, an image capture unit 15, a fill light 16, a sensing unit 17, and an artificial intelligence (AI) detection unit 18. The processor 11 acquires a current electric quantity value S of the camera 1 from the battery 14 and acquires the detection results of the sensing unit 17 by executing the processes in the embodiment of the method for prolonging battery usage life of a camera described below, and controls the camera 1 to operate in a camera shooting mode corresponding to the current electric quantity value S, for example, to control the video recording frame rate of the image capture unit 15 and the luminous power of the fill light 16, or to control the image capture unit 15 and the fill light 16 to stop operating so as to enter the standby state. The processor 11 also controls the turning on and off the AI detection unit in dependence on the current electric quantity value S.

The image capture unit 15 is configured to record video images of the monitored area. The maximum video recording frame rate of the image capture unit 15 is Fₘₐₓ, i.e., the number of image frames acquired by the image capture unit 15 per second. It will be appreciated that the greater the video recording frame rate of the image capture unit 15, the greater the power consumption of the image capture unit 15.

The fill light 16 is configured to enhance illumination intensity of the monitored area so as to improve the effect of the image capture unit 15 in recording video data of the monitored area. The maximum luminous power of the fill light 16 is Wₘₐₓ. The greater the luminous power of the fill light 16, the more power consumption will be when the fill light 16 is operated. The fill light 16 may be an infrared lamp, a white light lamp, an LED fill light, a stroboscopic fill light, etc. The infrared lamp is mainly used for nighttime or extremely poor light environment, providing invisible infrared light so that the image capture unit 15 captures an image. The white light lamp is used to provide visible light so that a color image capture unit can capture a color image in a low light environment or at night.

The sensing unit 17 is referred to as a sensor unit capable of sensing infrared radiation, such as a Passive Infrared (PIR) unit. If a human body enters the monitored area, the sensing unit 17 may sense an infrared heat source radiated from the human body.

The AI detection unit 18, using in-depth learning and computer vision techniques to analyze the images acquired by the image capture unit 15 and the recorded video data, is capable of automatically identifying objects, behaviors and scenes, such as identifying intruding targets in the monitored area.

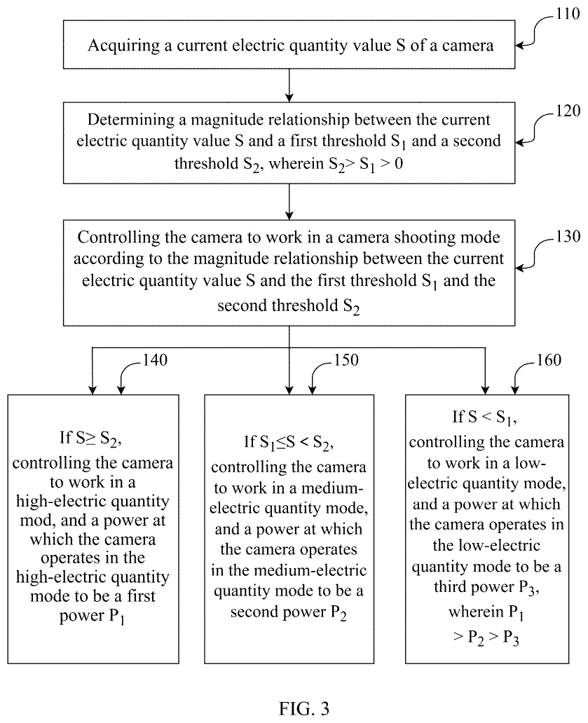

FIG. 3 is a schematic flow chart showing a method for prolonging battery usage life of a camera according to an embodiment of the present application. In the embodiment of the present application, the method for prolonging battery usage life of a camera may be executed by a controller (e.g., the processor 11) in the camera 1. As shown in FIG. 3, the method comprises the following processes.

In step 110, acquiring a current electric quantity value S of the camera 1.

The current electric quantity value S refers to the remaining electric quantity value of the camera 1 at the current time, and may be expressed as a proportion, that is, the proportion of the remaining electric quantity of the camera 1 at the current time to the total electric quantity when the battery is fully charged. Since the remaining electric quantity of the camera 1 is a main factor affecting the battery life time thereof, by acquiring the current electric quantity value S, a mode (i.e., an operation mode) adapted to the current electric quantity value S can be further determined for the camera 1, so as to improve the battery life time of the camera 1.

In step 120, determining a magnitude relationship between the current electric quantity value S and a first threshold S₁, and the magnitude relationship between the current electric quantity value and a second threshold S₂, wherein S₂>S₁>0.

If the current electric quantity value S is represented by the proportion, the first threshold S₁ and the second threshold S₂ are also represented by the proportion. The electric quantity is divided into three sections by S₁ and S₂, i.e., 0-S₁ section, S₁-S₂ section and S₂-100% section. If the current electric quantity value S falls within the interval 0-S₁, it is indicated that the remaining electric quantity of the camera 1 is relatively small; if the current electric quantity value S falls within the interval [S₁, S₂], it is indicated that the remaining electric quantity of the camera 1 is at an intermediate level; if the current electric quantity value S falls within the interval [S₂, 100%], it is indicated that there is more electric quantity remaining in the camera 1. The first threshold S₁ and the second threshold S₂ can be set as required, for example, the first threshold S₁ is set to 10%, 20% or 35%, and the second threshold S₂ is set to 55%, 65% or 70%. By determining the magnitude relationship between the electric quantity value S and the first threshold S₁, and the magnitude relationship between the electric quantity value S and the second threshold S₂, it is possible to know whether the electric quantity remaining in the camera 1 is small or large. The first threshold S₁ and the second threshold S₂ can be fixed values or adjustable values, and are set or adjusted by user-defined settings by the electronic device 2.

It is worth mentioning that if it is determined that S is less than or equal to S₁, it is not necessary to continue to determine the magnitude relationship between S and S₂. If it is determined that S is greater than or equal to S₂, it is not necessary to continue to determine the magnitude relationship between S and S₁.

In step 130, controlling the camera 1 to work in a camera shooting mode according to the magnitude relationship between the current electric quantity value S and the first threshold S₁ and the second threshold S₂. In the embodiment, the camera shooting mode includes high-electric quantity mode, a medium-electric quantity mode, and a low-electric quantity mode.

In step 140, when the electric quantity value S is greater than or equal to the second threshold S₂, i.e., S≥S₂, controlling the camera 1 to work in a high-electric quantity mod, and a power at which the camera 1 operates in the high-electric quantity mode to be a first power P₁.

In step 150, when the electric quantity value S is greater than or equal to the first threshold S₁ but is less than the second threshold S₂, i.e., S₁≤S≤S₂, controlling the camera 1 to work in a medium-electric quantity mode, and a power at which the camera 1 operates in the medium-electric quantity mode to be a second power P₂.

In step 160, when the electric quantity value S is less than the first threshold S₁, i.e., S<S₁, controlling the camera 1 to work in a low-electric quantity mode, and a power at which the camera 1 operates in the low-electric quantity mode to be a third power P₃, wherein the first power P₁ is greater than the second power P₂, and the second power P₂ is greater than the third power P₃, i.e., P₁>P₂>P₃.

In the same operation duration, the greater the power of the camera 1 is, the more power is consumed. The power of the camera 1 is the sum of the powers of the respective units in the camera 1. The main power consumption units in the camera 1 include an image capture unit 15, a fill light 16, a sensing unit 17, an AI detection unit 18, etc. Since the camera 1 works in different camera shooting modes, and the power of each unit in the camera 1 is determined by the operating state of each unit, the operating state of each unit in the camera 1 is also different in different camera shooting modes.

Since the operating state of each unit in the camera 1 is also different in different camera shooting modes, the camera 1 is controlled to work in the corresponding camera shooting mode according to the current electric quantity value S of the camera 1, and the operating state of each unit in the camera 1 is the operating state corresponding to the camera shooting mode.

In the embodiment of the present application, the camera 1 is controlled to work in the corresponding camera shooting mode according to a current electric quantity value S of the camera 1. If the current electric quantity value S belongs to different electric quantity intervals, the camera shooting modes corresponding to the electric quantity value S are also different, and when the camera is operated in different modes, the power consumption of the camera is also different. When the current electric quantity value S is small, the camera is operated in the camera shooting mode in which the power and the power consumption are also low, so that the battery usage life of the camera 1 is prolonged as compared with the case where the camera 1 is always operated in a single mode in which the power consumption is high.

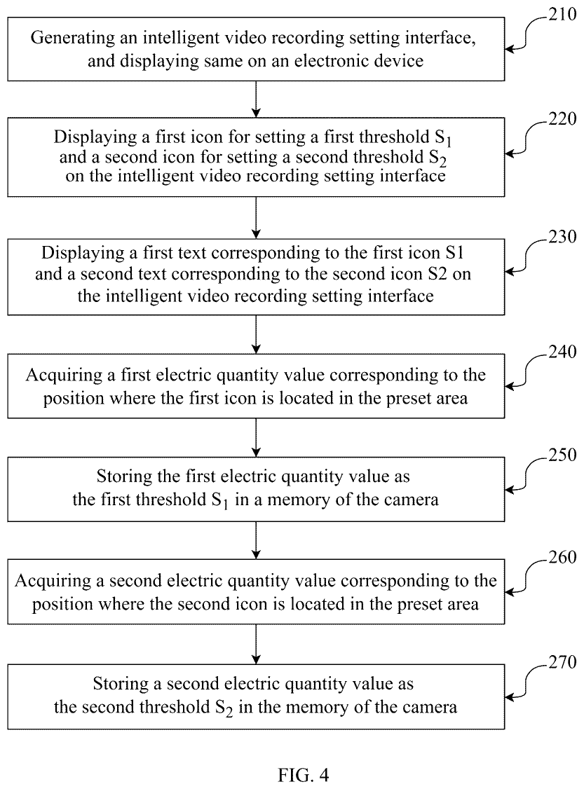

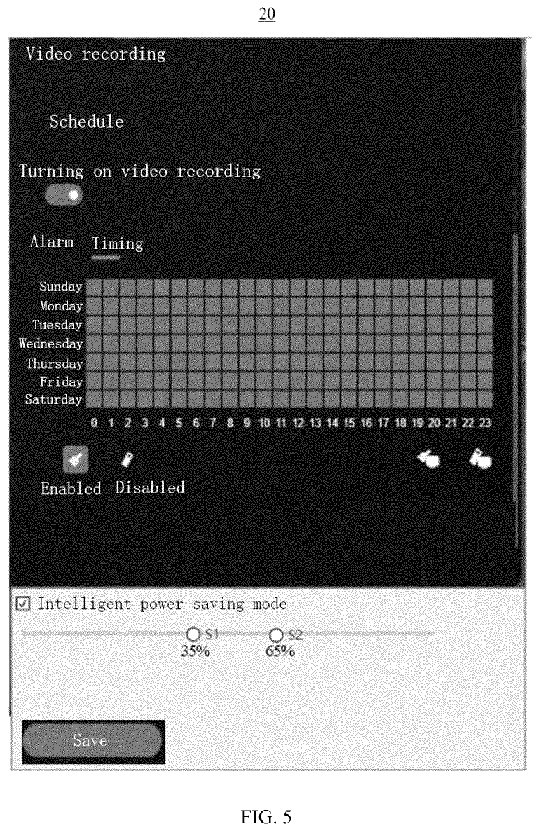

FIG. 4 is a schematic flow chart showing a method for setting a first threshold S₁ and a second threshold S₂ according to an embodiment of the present application. As shown in FIG. 4, the method includes the following steps of:

In step 210, generating an intelligent video recording setting interface and displaying same on an electronic device 2, wherein the electronic device 2 is communicatively connected to a camera 1.

Here, for the convenience of describing the intelligent video recording setting interface displayed on the electronic device 2, FIG. 5 is a schematic diagram showing an intelligent video recording setting interface displayed on an electronic device according to an embodiment of the present application. In the present embodiment, the intelligent video recording setting interface 20 may be generated by the camera 1 and displayed on the screen of the electronic device 2 with which the camera 1 is communicatively connected. In other embodiments, the intelligent video recording setting interface 20 may also be generated by the electronic device 2 and displayed on a display screen of the electronic device 2. As shown in FIG. 5, the camera 1 generates an intelligent video recording setting interface 20 and displays it on the screen of the electronic device 2 for the user to set the thresholds of the electric quantity required for the camera 1 to operate in different camera shooting modes, for example, the first threshold S₁ and the second threshold S₂. The electronic device 2 can display different user interfaces (for example, an intelligent video recording setting interface 20 as shown in FIG. 5) for a user to set various monitoring parameters of the camera 1 and electric quantity thresholds in different camera shooting modes, and send the electric quantity thresholds in different camera shooting modes to the camera 1 for storage. In addition, the electronic device 2 is also used for receiving a monitoring video recording sent by the camera 1 for a user to browse, etc. when the user browses the monitoring video recording.

Before the user needs to control the intelligent video recording mode of the camera 1, the electronic device 2 establishes a communication connection with the camera 1 via the net operate 3, and the specific communication connection implementation method is not limited in this embodiment. After the electronic device 2 establishes the communication connection with the camera 1, the intelligent video recording setting interface 20 is displayed on the screen of the electronic device 2 for the user to set the threshold of the electric quantity required for the camera 1 to operate in different camera shooting modes.

In step 220, displaying a first icon for setting a first threshold S₁ and a second icon for setting a second threshold S₂ on the intelligent video recording setting interface 20, where the first icon S1 and the second icon S2 are used for sliding in a preset area by the user's fingers, and different positions of the first icon S1 and the second icon S2 in the preset area correspond to different electric quantity values.

In step 230, displaying a first text corresponding to the first icon S1 and a second text corresponding to the second icon S2 on the intelligent video recording setting interface 20. The contents displayed by the first text and the second text are respectively electric quantity values corresponding to positions where the first icon S1 and the second icon S2 are located.

As shown in FIG. 5, the first icon S1 and the second icon S2 in the figure can slide left and right in a preset area. The content shown in the first text in the figure is 35%, which indicates that the electric quantity value corresponding to the current position of the first icon S1 is 35%; the content shown in the second text in the figure is 65%, which indicates that the electric quantity value corresponding to the current position of the second icon S2 is 65%.

In step 240, acquiring a first electric quantity value corresponding to the position where the first icon is located in the preset area.

Different positions of the first icon S1 in the preset area correspond to different electric quantity values. The position where the first icon S1 is located may be preset or may be set by the user himself. The first threshold S₁ can be set by acquiring the first electric quantity value corresponding to a position where the first icon S1 is located in the preset area at the current time. In some embodiments, the minimum value of the first electric quantity value is 10% of the maximum charge capacity of the battery in order to better prolong battery usage life of the camera 1.

In step 250, storing the first electric quantity value as the first threshold S₁ in the memory 12 of the camera 1.

The first electric quantity value is stored in the memory 12 of the camera 1 as the first threshold S₁, so that the processor of the camera 1 can directly read the first threshold S₁ from the memory of the camera 1 when executing the method for controlling battery life of a camera provided in FIG. 3.

In step 260, acquiring a second electric quantity value corresponding to the position where the second icon is located in the preset area.

In step 270, storing the second electric quantity value as the second threshold S₂ in the memory 12 of the camera 1.

The steps 260 to 270 are similar to the steps 240 to 250, and therefore, the principle and implementation of the steps 260 to 270 can be referred to the steps 240 to 250, which will not be described in detail herein.

In the embodiment of the present application, a user can slide the first icon S1 and the second icon S2 in the preset area in the intelligent video recording setting interface 20 displayed on the screen of the electronic device 2 so as to set the first threshold S₁ and the second threshold S₂, so that different requirements of the user can be satisfied. Furthermore, a first text and a second text are displayed on the intelligent video recording setting interface 20, the contents displayed by the first text and the second text are respectively electric quantity values corresponding to the positions where the first icon S1 and the second icon S2 are located, and the first text and the second text can move along with the sliding of the first icon S1 and the second icon S2 respectively, so that a user can directly and quickly learn the electric quantity values corresponding to the positions where the first icon S1 and the second icon S2 are located from the contents displayed by the first text and the second text, thereby improving the user experience.

To further enhance the user experience, in some embodiments, the first icon S1 is displayed in a first color, e.g., red. The second icon S2 is displayed in a second color, e.g., blue. The user experience is further improved by arranging that the first icon S1 and the second icon S2 are displayed in different colors so that the user can quickly distinguish between the first icon S1 and the second icon S2.

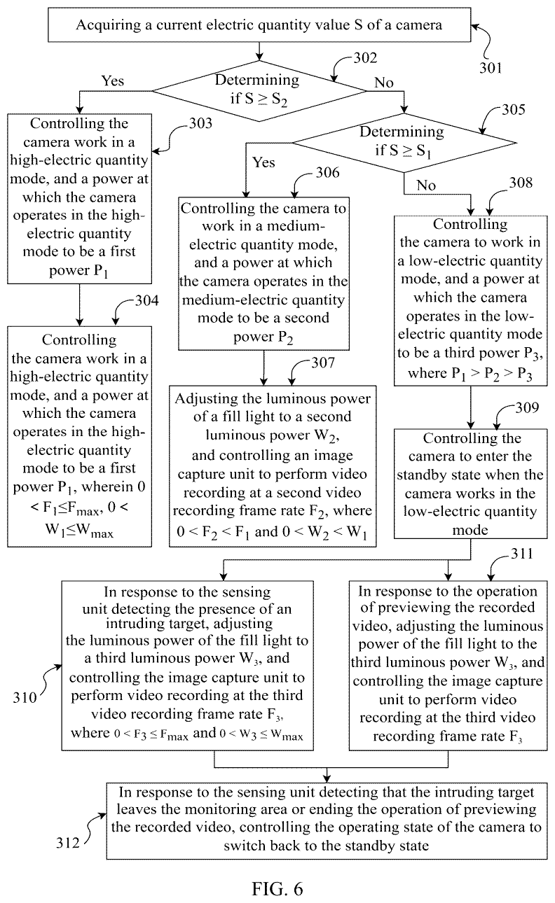

FIG. 6 is a schematic flow chart showing a method for prolonging battery usage life of a camera according to another embodiment of the present application. As shown in FIG. 6, the method includes the following steps of:

In step 301, acquiring a current electric quantity value S of a camera 1.

The present step is the same as step 110, and therefore, the principle and specific implementation of the present step can be referred to step 110, which will not be described in detail.

In step 302, determining whether the current electric quantity value S is greater than or equal to the second threshold S₂, i.e., S≥S₂. If so, proceed to step 303; if not, proceed to step 305.

In step 303, controlling the camera 1 work in a high-electric quantity mode, and a power at which the camera 1 operates in the high-electric quantity mode to be a first power P₁.

In step 304, adjusting a luminous power of a fill light to a first luminous power W₁, and control an image capture unit 15 to record at a first video recording frame rate F₁, wherein 0<F₁≤Fₘₐₓ, 0<W₁≤Wₘₐₓ.

Within a certain range, the greater the video recording frame rate of the video recorded by the image capture unit 15, the better the fluency of the video obtained from the video recording. The greater the luminous power of the fill light 16, the greater the illumination intensity. In steps 303 and 304, since the current electric quantity value S is greater than or equal to the second threshold S₂, it is indicated that the electric quantity remaining in the camera 1 at the current time is sufficient, and by controlling the camera 1 works in a high-electric quantity mode so as to control the luminous power of the fill light 16 to be adjusted to a larger first power W₁, the image capture unit 15 performs video recording at a larger first video recording frame rate F₁, thereby ensuring the clarity and fluency of the video obtained from the video recording.

It is worth mentioning that the turning on and off of the fill light 16 is determined by the illumination intensity of the monitored area, independently of the current electric quantity value S. If the illumination intensity of the monitored area is weak and cannot meet the requirements of the video recording, the fill light 16 is controlled to turn on to enhance the illumination intensity of the monitored area. If the illumination intensity of the monitored area can meet the video recording requirements, it is not necessary to turn on the fill light 16. When the fill light is turned on, the luminous power thereof is adjusted according to the current electric quantity value S.

Therefore, in step 304, the luminous power of the fill light 16 is adjusted to be a first power W₁, and the image capture unit 15 is controlled to perform video recording at a first video recording frame rate F₁, which specifically means that the image capture unit 15 is controlled to perform video recording on the monitored area at the first video recording frame rate F₁; and if the illumination intensity of the monitored area is weak, the fill light 16 needs to be turned on so as to enhance the illumination intensity of the monitored area, the fill light 16 operates with the luminous power as the first luminous power W₁. If the illumination intensity of the monitored area meets the video recording requirements, it is not necessary to turn on the fill light 16. It should be noted that the above explanation applies to the steps similar to step 304 throughout, and the explanation will not be repeated later.

In this step, the first luminous power W₁ and the first video recording frame rate F₁ may be set as required, and may generally be set to a larger value. For example, the first luminous power W₁ may be set to Wₘₐₓ, 0.9×Wₘₐₓ, or 0.8×Wₘₐₓ, and the first video recording frame rate F₁ may be set to Fₘₐₓ, 0.9×Fₘₐₓ, or 0.8×Fₘₐₓ. When F₁=Fₘₐₓ and W₁=Wₘₐₓ, the fill light 16 is operated at its maximum luminous power Wₘₐₓ, and the image capture unit 15 is operated at its maximum video recording frame rate, so as to sufficiently ensure that the clarity and fluency of the video obtained from video recording reach an optimal state.

In step 305, determining whether the current electric quantity value S is greater than or equal to the first threshold S₁. If so, proceed to step 306; if not, proceed to step 308.

In step 306, controlling the camera 1 to work in a medium-electric quantity mode, and a power at which the camera 1 operates in the medium-electric quantity mode to be a second power P₂.

In step 307, adjusting the luminous power of the fill light 16 to a second luminous power W₂, and controlling an image capture unit 15 to perform video recording at a second video recording frame rate F₂, where 0<F₂<F₁ and 0<W₂<W₁.

If the electric quantity value S is greater than or equal to the first threshold S₁ but is less than the second threshold S₂, i.e., S₁≤S<S₂, it is indicated that the electric quantity remaining in the camera 1 at the current time is at an intermediate level, and compared with the case where the electric quantity remaining in the camera 1 is large, in steps 306-307, the camera 1 is controlled to work in a medium-electric quantity mode, the luminous power of the fill light is adjusted to a second luminous power W₂ which is smaller than the first luminous power W₁, and the image capture unit is controlled to perform video recording at a second video recording frame rate F₂ which is smaller than the first video recording frame rate F₁, thereby effectively reducing the power of the camera 1, and thus reducing the power consumption of the camera 1; as a result, the battery usage life time of the camera 1 is prolonged.

The second luminous power W₂ and the second video recording frame rate F₂ may be set as required, for example, the second luminous power W₂ may be set to 0.6×Wₘₐₓ, 0.5×Wₘₐₓ or 0.4×Wₘₐₓ, and the second video recording frame rate F₂ may be set to 0.6×Fₘₐₓ, 0.5×Fₘₐₓ or 0.433 Fₘₐₓ.

In step 308, controlling the camera 1 to work in a low-electric quantity mode, and a power at which the camera 1 operates in the low-electric quantity mode to be a third power P₃, where P₁>P₂>P₃.

In step 309, controlling the camera 1 to enter the standby state when the camera 1 works in the low-electric quantity mode, where when the camera 1 is in the standby state, the sensing unit 17 is in the operating state.

If the electric quantity value S is less than the first threshold S₁, i.e., S<S₁, it is indicated that the electric quantity remaining in the camera 1 at the current time is small. Therefore, when the camera 1 is controlled to enter the standby state in steps 308 to 309, the image capture unit 15 and the fill light 16 also enter the standby state, so that the power consumption of the camera 1 is reduced, and the battery life time of the camera 1 is prolonged.

In the standby state, all the other units except the sensing unit 17 can be turned off to save power consumption. Since the power consumption of the sensing unit 17 is generally low, the sensing unit 17 will not consume too much power for continued operation. Therefore, in step 309, when controlling the camera 1 to enter the standby state, the sensing unit 17 is in the operating state, and the safety monitoring of the monitored area is continuously maintained, so as to ensure the safety monitoring effect without consuming much power.

In step 310, when the camera 1 is in the standby state, in response to the sensing unit 17 of the cameral detecting the presence of an intruding target, adjusting the luminous power of the fill light to a third luminous power W₃, and controlling the image capture unit to perform video recording at the third video recording frame rate F₃, where 0<F₃≤Fₘₐₓ, and 0<W₃≤Wₘₐₓ.

When the camera 1 is in the standby state, if the sensing unit 17 detecting the presence of the intruding target in the monitored area, the camera 1 is woken up, and the camera 1 is controlled to perform a video recording to monitor the intruding target. The third luminous power W₃ and the third video recording frame rate F₃ can be set as required, for example, the third luminous power W₃ can be set to Wₘₐₓ, 0.9*Wₘₐₓ or 0.8*Wₘₐₓ, and the third video recording frame rate F₃ can be set to Fₘₐₓ, 0.9*Fₘₐₓ or 0.8*Fₘₐₓ. When F₃=Fₘₐₓ and W₃=Wₘₐₓ, the fill light is operated at its maximum luminous power, and the image capture unit 15 is operated at its maximum video recording frame rate, which can sufficiently ensure the clarity and fluency of the video obtained from video recording upon presence of an intruding target.

In step 311, when the camera 1 is in the standby state, in response to the operation of previewing the recorded video, adjusting the luminous power of the fill light 16 to the third luminous power W₃, and controlling the image capture unit 15 to perform video recording at the third video recording frame rate F₃.

In order to improve the user experience, the user can view the video recorded by the camera 1 via the electronic device 2 communicatively connected to the camera 1, so as to facilitate the user to know what happens in the monitored area in real time, for example, whether there is an intruding target in the monitored area, for example, the user can view the video recorded by the camera 1 in real time via a mobile phone. In this step, the operation of previewing the recorded video can be an operation performed by a user on the electronic device 2 communicatively connected to the camera 1, and the video obtained from real-time video recording by the camera 1 is viewed through the operation. Therefore, when the camera 1 is in a standby state, if the user selects to preview a recorded video, the camera 1 is woken up, and the camera 1 is controlled to perform a video recording, so that the user can know the security of the current monitored area through the video recorded by the camera 1.

In step 312, in response to the sensing unit detecting that the intruding target leaves the monitoring area, or ending the operation of previewing the recorded video, controlling the operating state of the camera to switch back to the standby state.

If the sensing unit 17 detects the intruding target leaving the monitored area, it is indicated that the monitored area is in a safe state, the image capture unit 15 and the fill light 16 may be turned off. When the user selects to end previewing the recorded video, the image capture unit 15 and the fill light 16 may be turned off. In this step, when it is detected that the intruding target leaves the monitored area or the user selects to end previewing the recorded video, the operating state of the camera 1 is timely controlled to switch back to the standby state, so that the power consumption of the camera 1 is reduced and the battery usage life time of the camera 1 is prolonged.

It is worth noting that in different camera shooting modes, the luminous power of the fill light 16 in the camera 1 and the video recording frame rate of the image capture unit 15 are different. When the camera 1 works in a low-electric quantity mode, the camera 1 enters the standby state, and at this time, the camera 1 does not perform video recording any more, i.e., the video recording frame rate is 0. When the sensing unit 17 detects presence of an intruding target in the monitored area or the user selects the operation of previewing the recorded video, in steps 310-311, the luminous power of the fill light 16 is adjusted to the third power W₃, and the image capture unit 15 is controlled to perform video recording at the third video recording frame rate F₃, it is indicated that the mode of the camera 1 is switched from the low-electric quantity mode to the luminous power of the fill light 16 to the third power W₃, and the image capture unit 15 performs a mode of performing video recording at the third video recording frame rate F₃. Therefore, in order to prolong the battery life time of the camera 1, when the sensing unit 17 detects the intruding target leaving the monitored area, or the user selects to end the operation of previewing the recorded video, the camera 1 is controlled to switch back to the low-electric quantity mode from the current camera shooting mode (the luminous power of the fill light 16 is the third luminous power W₃, and the image capture unit 15 performs video recording at the third video recording frame rate F₃), that is, the camera 1 enters the standby state. The above explanation is applied to the steps similar to the steps 310 to 312 in the following, and the explanation will not be repeated later.

It should be noted that in the embodiment shown in FIG. 6, step 302 and step 305 are taken as an example to determine a magnitude relationship between S and S₁ and between S and S₂. In some embodiments, it may be determined whether the electric quantity value S is less than the first threshold S₁, and when the electric quantity value S is greater than or equal to the first threshold S₁, it may be determined whether the electric quantity value S is greater than or equal to the second threshold S₂ or whether the electric quantity value S is less than the second threshold S₂, and other determination sequences may also be used, which is not limited herein.

In the embodiment of the present application, if the remaining electric quantity of the camera 1 at the current time is relatively large, the luminous power of the fill light 16 is adjusted to a relatively large power, and the camera 1 is controlled to perform video recording at a relatively large video recording frame rate, so as to ensure that the video obtained from the video recording has better clarity and better fluency. If the remaining electric quantity of the camera 1 is at an intermediate level at the current time, the luminous power of the fill light is adjusted to a lower power, and the camera 1 is controlled to perform video recording at a lower video recording frame rate, thereby extending the battery life time of the camera 1 and satisfying the requirement of stable video recording for a long time. If the remaining electric quantity of the camera 1 at the current time is less, then in the case where there is no intruding target in the monitored area and the user does not select to preview the recorded video, the operating state of the camera 1 is controlled to enter a standby state, so as to reduce the power consumption of the camera 1, so that upon presence of an intruding target in the monitored area or the user selects to preview the recorded video in a longer period, the camera 1 can still perform video recording in time, so as to realize the function of the camera 1 monitoring the monitored area.

Based on the foregoing embodiment, in the embodiment of the present application, the method for prolonging battery usage life of a camera further includes the steps of:

In step a01, when the camera 1 works in the medium-electric quantity mode, in response to the sensing unit 17 detecting presence of an intruding target in a monitored area, adjusting the luminous power of the fill light to a third luminous power W₃, and controlling the image capture unit 15 to perform video recording at a third video recording frame rate F₃, wherein 0<F₂<F₃≤Fₘₐₓ, and 0<W₂<W₃≤Wₘₐₓ.

In step a02, when the camera 1 works in the medium-electric quantity mode, in response to the operation of previewing the recorded video, adjusting the luminous power of the fill light 16 to a third luminous power W₃, and control the image capture unit to perform the video recording at the third video recording frame rate F₃.

In step a03, in response to the sensing unit 17 detecting the intruding target leaving the monitored area, or ending the operation of previewing the recorded video, controlling the mode of the camera to switch back to the medium-electric quantity mode.

The steps a01-a03 are similar to steps 310-312, and therefore, the principle and implementation of steps a01-a03 can be referred to the steps 310-312, which will not be described in detail herein.

In the embodiment of the present application, when the camera 1 works in a medium-electric quantity mode, that is to say, when the remaining electric quantity of the camera 1 is at an intermediate level, if the sensing unit 17 detects presence of an intruding target in the monitored area, the luminous power of the fill light 16 is adjusted from the lower second luminous power W₂ to the higher third luminous power W₃ in time, and the video recording frame rate of the image capture unit 15 is adjusted from the lower second video recording frame rate F₂ to the higher third video recording frame rate F₃, so that better monitoring can be performed on the intruding target, and the case where the entire behavior of the intruding target within the monitored area cannot be completely recorded due to the small video recording frame rate of the image capture unit 15, and the case where the intruding target cannot be effectively discriminated from the video obtained from the video recording due to the weak illumination intensity of the monitored area are avoided. When the user selects to preview the recorded video, the illuminous power of the fill light 16 and the video recording frame rate of the image capture unit 15 are increased in time to improve the clarity and fluency of the video obtained from the video recording. After detecting the intruding target leaving the monitored area or the user finishes previewing the recorded video, the sensing unit 17 switches the mode of the camera 1 from the higher-power mode back to the lower-power medium-electric quantity mode in time, thereby extending battery usage life time of the camera.

In some embodiments, the first video recording frame rate F₁ is set to Fₘₐₓ and the first power W₁ is set to Wₘₐₓ in order to further improve the clarity and fluency of the video obtained from video recording. In the embodiment of the present application, if the remaining electric quantity of the camera 1 is relatively large, by setting the video recording frame rate of the image capture unit as the maximum video recording frame rate, the fluency of the video recorded by the image capture unit reaches an optimal state. By setting the luminous power of the fill light as the maximum luminous power, when the fill light is in an on state, the illumination intensity of the monitored area can reach an optimal state, and the clarity of the video recorded by the image capture unit is improved.

In some embodiments, step 310 and/or step a01 include:

Step b01, in response to the sensing unit 17 detecting the presence of the intruding target in the monitored area, controlling the AI detection unit 18 to acquire a current image acquired at a current time of the image capture unit 15, and perform intruding target identification on the current image.

For other sensing units, such as PIR units, a misjudgment may occur when identifying whether there is an intruding target in the monitored area, especially in scenarios such as leaf shaking, having a hotter airflow, or even light changes, etc. Therefore, the camera 1 is provided with the AI detection unit 18, and humanoid identification, vehicle type identification, etc. are performed on the current image by the AI detection unit 18, thereby improving the accuracy of determining whether there is the intruding target in the monitored area.

If the camera 1 is in a standby state, after the sensing unit 17 detects the presence of the intruding target in the monitored area, the image capture unit 15 is woken up to capture the monitored area so as to obtain a current image, and the AI detection unit 18 is controlled to perform intruding target identification on the current image. If the mode of the camera 1 is the medium-electric quantity mode, the control AI detection unit 18 directly acquires the current image captured by the image capture unit 15 at the current time, and performs intruding target identification on the current image.

Step b02, if the AI detection unit 18 identifies the intruding target from the current image, adjusting the luminous power of the fill light to the third luminous power W₃, and controlling the image capture unit 15 to perform video recording at the third video recording frame rate F₃.

The present step is similar to step 310, and therefore, the principle and specific implementation of the present step can be referred to step 310, which will not be described in detail.

In the embodiment of the present application, by providing the AI detection unit 18 in the camera 1, only when both the sensing unit 17 and the AI detection unit 18 detect the intruding target, the presence of the intruding target in the monitored area is confirmed, and compared with the method of only detecting whether the intruding target is present in the monitored area by means of the sensing unit 17, the misjudgment can be reduced and the accuracy of the judgement can be improved.

In some embodiments, the third video recording frame rate F₃ is set to Fₘₐₓ and the third luminous power W₃ is set to the maximum luminous power Wₘₐₓ in order to completely record all of the behavior of the intruding target in the monitored area and to improve the user experience while previewing the recorded video.

In some embodiments, based on the embodiment provided in FIG. 3, after step 120, the method for prolonging battery usage life of a camera further includes:

Step c01, if the electric quantity value S is greater than or equal to the second threshold S₂, i.e., S≥S₂, controlling the AI detection unit 18 to parse the video recorded by the camera 1.

If S≥S₂, it is indicated that there is a large electric quantity remaining in the camera, the AI detection unit 18 may be started to parse the video. The AI detection unit 18 parses the video recorded by the camera 1, including adding labels or tags to specific objects in the video picture, such as people, cars, animals, etc. using the AI detection unit 18, and framing the objects using a detection frame, so that a user can quickly locate the objects when browsing the video.

Step c02: if the electric quantity value S is less than the second threshold S₂, i.e., S<S₂, turn off the AI detection unit 18.

If S<S₂, it is indicated that the electric quantity remaining in the camera 1 is not large, and by turning off the AI detection unit 18, it is possible to reduce the power consumption of the camera 1 and thus to prolong the battery life time. In addition, the most important function of the camera 1 is to perform video recording monitoring on the monitored area, and the AI detection unit 18 is used to parse the video recording, only for the convenience of the user to quickly locate the target; therefore, in the case where the remaining electric quantity of the camera 1 is small, by turning off the AI detection unit 18, the camera 1 can continue to perform its monitoring duties within a long time, so as to ensure the safety of the monitored area.

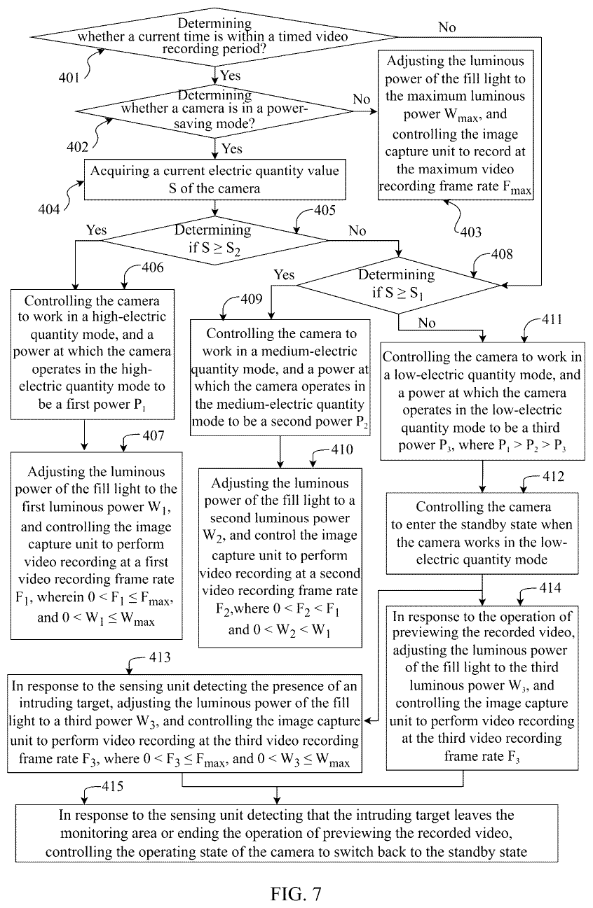

In order to further increase the battery life time of the camera, FIG. 7 is a schematic flow chart showing a method for controlling battery life of a camera according to still another embodiment of the present application. As shown in FIG. 7, the method includes the following steps of:

In step 401, determining whether a current time is within a preset timed video recording period. If so, proceed to step 402; if not, proceed to step 411.

The preset timed video recording period refers to a recording period preset by the user, that is, during this period, the user needs the camera 1 to perform video recording.

In step 402, determining whether the camera 1 is configured in a power-saving mode. If not, proceed to step 403; if so, proceed to step 404.

When the camera 1 is operated in the power-saving mode, the steps described in the foregoing embodiment, for example, steps 404 to 415 described below, are executed to prolong the battery usage life time of the camera 1.

In step 403, adjusting the luminous power of the fill light 16 to the maximum luminous power Wₘₐₓ, and controlling the image capture unit 15 to record at the maximum video recording frame rate Fₘₐₓ.

If the camera 1 is not configured in the power-saving mode, the operating states of the fill light 16 and the image capture unit 15 are adjusted to the maximum power state.

In step 404, acquiring a current electric quantity value S of the camera 1.

In step 405, determining whether the electric quantity value S is greater than or equal to the second threshold S₂, i.e., S>S₂. If so, proceed to step 406; if not, proceed to step 408.

In step 406, controlling the camera 1 to work in a high-electric quantity mode, and a power at which the camera 1 operates in the high-electric quantity mode to be the first power P₁.

In step 407, adjusting the luminous power of the fill light 16 to the first luminous power W₁, and controlling the image capture unit 15 to perform video recording at a first video recording frame rate F₁, where 0<F₁≤Fₘₐₓ, and 0<W₁≤Wₘₐₓ.

In step 408, determining whether the electric quantity value S is greater than or equal to the first threshold S₁, i.e., S≥S₁. If so, proceed to step 409; if not, proceed to step 411.

In step 409, controlling the camera 1 to work in a medium-electric quantity mode, and a power at which the camera operates in the medium-electric quantity mode to be the second power P₂.

In step 410, adjusting the luminous power of the fill light 16 to a second luminous power W₂, and control an image capture unit 15 to perform video recording at a second video recording frame rate F₂, where 0<F₂<F₁ and 0<W₂<W₁.

In step 411, controlling the camera 1 to work in a low-electric quantity mode, and a power at which the camera operates in the low-electric quantity mode to be the third power P₃, where P₁>P₂>P₃.

In step 412, when the camera 1 works in the low-electric quantity mode, controlling the camera 1 to enter the standby state, where when the camera 1 is in the standby state, the sensing unit 17 is in the operating state.

In step 413, when the camera 1 is in the standby state, in response to the sensing unit 17 detecting the presence of an intruding target, adjusting the luminous power of the fill light to a third luminous power W₃, and controlling the image capture unit 15 to perform video recording at the third video recording frame rate F₃, where 0<F₃≤Fₘₐₓ, and 0<W₃≤Wₘₐₓ.

In step 414, when the camera 1 is in the standby state, in response to the operation of previewing the recorded video, adjusting the luminous power of the fill light 16 to the third luminous power W₃, and controlling the image capture unit 15 to perform video recording at the third video recording frame rate F₃.

In step 415, in response to the sensing unit 107 detecting that the intruding target leaves the monitoring area or ending the operation of previewing the recorded video, controlling the operating state of the camera 1 to switch back to the standby state.

The steps 404 to 415 are the same as the steps 301 to 312, and therefore, the principle and implementation of the steps 404 to 415 can be referred to the steps 301 to 312, which will not be described in detail herein.

In the embodiment of the present application, by determining whether the current time is within the preset timed video recording period, and if the current time is not within the preset timed video recording period, it is indicated that the user does not need to perform video recording by the camera 1; therefore, by controlling the camera 1 to enter the standby state, it is possible to reduce the power consumption of the camera 1 and prolong the battery usage life time. If the current time is within a preset timed video recording period, it is further determined whether the camera 1 is configured in a power-saving mode. If the camera is configured in the power-saving mode, the camera 1 is controlled to operate in the power-saving mode; and if the camera is not configured in the power-saving mode, the camera 1 is controlled to operate in a high-power mode. In this way, the user's different needs can be met, and the user experience can be improved.

The embodiments of the present application provide a computer-readable storage medium having stored thereon executable instructions which, when executed on a camera, cause the camera to execute a method for prolonging battery usage life of the camera 1 in any one of the method embodiments described above.

The embodiments of the present application provide a computer program that can be called by a processor to cause a camera to execute the method for prolong battery usage life of the camera in any one of the method embodiments described above.

The embodiments of the present application provide a computer program product including a computer program stored on a computer-readable storage medium, the computer program including program instructions which, when executed on a computer, cause the computer to execute a method for prolonging battery usage life of a camera in any one of the method embodiments described above.

The camera and the method for prolonging battery usage life of a camera proposed in the embodiment of the present application improve the battery life time of the camera without involving the improvement of the hardware of the camera, and control the camera to operate in the corresponding camera shooting mode by acquiring the current electric quantity value of the camera, and determining the camera shooting mode of the camera according to the current electric quantity value. When the current electric quantity value is small, the power of the camera in the corresponding mode is also small, so that the camera is not continuously in a high-power operating state, thereby prolonging the battery usage life time of the camera.

It should be noted that the above-mentioned embodiments illustrate rather than limit the application, and that a person skilled in the art will be able to design alternative embodiments without departing from the scope. The steps in the above embodiments are not to be construed as limiting the order of execution unless otherwise specified.

What is claimed is:

1. A method for prolonging battery usage life of a camera, comprising:
acquiring an electric quantity value of the camera;
determining a magnitude relationship between the electric quantity value and a first threshold, and the magnitude relationship between the electric quantity value and a second threshold, wherein the second threshold is greater than the first threshold;
controlling the camera to work in a high-electric quantity mode if the electric quantity value is greater than or equal to the second threshold, and a power at which the camera operates in the high-electric quantity mode to be a first power;
controlling the camera to work in a medium-electric quantity mode if the electric quantity value is greater than or equal to the first threshold but is less than the second threshold, and a power at which the camera operates in the medium-electric quantity mode to be a second power; and
controlling the camera to work in a low-electric quantity mode if the electric quantity value is less than the first threshold, and a power at which the camera operates in the low-electric quantity mode to be a third power;
wherein the first power is greater than the second power, and the second power is greater than the third power.

2. The method according to claim 1, further comprising:
generating a video recording interface and displaying same on an electronic device being communicatively connected to the camera;
displaying a first icon for setting the first threshold and a second icon for setting the second threshold on the video recording interface, wherein the first icon and the second icon are used for sliding in a preset area, and different positions of the first icon and the second icon in the preset area correspond to different electric quantity values; and
displaying one first text corresponding to the first icon and one second text corresponding to the second icon on the video recording interface, wherein the contents displayed by the first text and the second text are respectively electric quantity values corresponding to positions where the first icon and the second icon are located.

3. The method according to claim 2, further comprising:
acquiring a first electric quantity value corresponding to the position where the first icon is located in the preset area;
storing the first electric quantity value as the first threshold in a memory of the camera;
acquiring a second electric quantity value corresponding to the position where the second icon is located in the preset area; and
storing the second electric quantity value as the second threshold in the memory of the camera.

4. The method according to claim 2, wherein the first icon is displayed in a first color and the second icon is displayed in a second color.

5. The method according to claim 1, further comprising:
when the camera works in the high-electric quantity mode, adjusting the luminous power of a fill light of the camera to a first luminous power W₁, and controlling an image capture unit of the camera to perform video recording at a first video recording frame rate F₁, wherein 0<F₁≤Fₘₐₓ, and 0<W₁≤Wₘₐₓ, here Fₘₐₓ is a maximum video recording frame rate of the image capture unit, and Wₘₐₓ is a maximum luminous power of the fill light.

6. The method according to claim 5, further comprising:
when the camera works in the medium-electric quantity mode, adjusting the luminous power of the fill light to a second luminous power W₂, and controlling an image capture unit of the camera to perform video recording at a second video recording frame rate F₂, wherein 0<F₂<F₁, and 0<W₂<W₁.

7. The method according to claim 6, further comprising:
in response to a sensing unit of the camera detecting presence of an intruding target in a monitored area, adjusting the luminous power of the fill light to a third luminous power W₃, and controlling the image capture unit to perform video recording at a third video recording frame rate F₃, wherein 0<F₂<F₃≤Fₘₐₓ, and 0<W₂<W₃≤Wₘₐₓ;
in response to an operation of previewing the recorded video, adjusting the luminous power of the fill light to the third luminous power W₃, and controlling the image capture unit to perform video recording at the third video recording frame rate F₃; and
in response to the sensing unit detecting the intruding target leaving the monitored area, or ending the operation of previewing the recorded video, controlling the mode of the camera to switch back to the medium-electric quantity mode.

8. The method according to claim 1, further comprising:
controlling the camera to enter a standby state when the camera works in the low-electric quantity mode, and controlling a sensing unit of the camera is in an operating state when the camera is in the standby state;
when the camera is in the standby state, in response to a sensing unit of the camera detecting the presence of the intruding target in a monitored area, adjusting the luminous power of a fill light of the camera to a third luminous power W₃, and controlling an image capture unit of the camera to perform video recording at a third video recording frame rate F₃, wherein 0<F₃≤Fₘₐₓ, and 0<W₃≤Wₘₐₓ, here Fₘₐₓ is a maximum video recording frame rate of the image capture unit, and Wₘₐₓ is a maximum luminous power of the fill light;
in response to an operation of previewing the recorded video, adjusting the luminous power of the fill light to the third luminous power W₃, and controlling the image capture unit to perform video recording at the third video recording frame rate F₃; and
in response to the sensing unit detecting the intruding target leaving the monitoring area, or ending the operation of previewing the recorded video, controlling the operating state of the camera to switch back to the standby state.

9. The method according to claim 8, further comprising:
in response to the sensing unit detecting the presence of the intruding target in the monitored area, controlling an AI detection unit of the camera to acquire a current image acquired at a current time of the image capture unit, and performing intruding target identification on the current image; and
if the AI detection unit identifies the intruding target from the current image, adjusting the luminous power of the fill light to the third luminous power W₃, and controlling the image capture unit to perform video recording at the third video recording frame rate F₃.

10. The method according to claim 1, further comprising:
controlling an AI detection unit of the camera to parse the video recorded by the camera if the electric quantity value is greater than or equal to the second threshold; and
turning off the AI detection unit if the electric quantity value is less than the second threshold.

11. The method according to claim 1, further comprising:
determining whether the current time is within a preset timed video recording period;
when the current time is within the timed video recording period, determining whether the camera is configured in a power-saving mode;
if the camera is configured in the power-saving mode, acquiring the electric quantity value S of the camera; or if the camera is not configured in the power-saving mode, adjusting the luminous power of a fill light of the camera to the maximum luminous power Wₘₐₓ, and controlling an image capture unit of the camera to perform video recording at the maximum video recording frame rate Fₘₐₓ;
when the current time is not within the timed video recording period, controlling the camera to enter the standby state, in response to a sensing unit of the camera detecting the presence of an intruding target or previewing the recorded video in a monitored area, adjusting the luminous power of the fill light to the third luminous power W₃, and controlling the image capture unit to perform video recording at the third video recording frame rate F₃, wherein 0<F₃≤Fₘₐₓ, and 0<W₃≤Wₘₐₓ; and
controlling the camera to enter the standby state in response to the sensing unit detecting the intruding target leaving the monitored area or ending the operation of previewing the recorded video.

12. A camera, comprising:
a memory configured to store a plurality of computer-executed instructions; and
at least one processor coupled to the memory and configured to execute the instructions stored in the memory to cause the camera to:
acquire an electric quantity value of the camera;
determine a magnitude relationship between the electric quantity value and a first threshold, and the magnitude relationship between the electric quantity value and a second threshold, wherein the second threshold is greater than the first threshold;
control the camera to work in a high-electric quantity mode if the electric quantity value is greater than or equal to the second threshold, and a power at which the camera operates in the high-electric quantity mode to be a first power;
control the camera to work in a medium-electric quantity mode if the electric quantity value is greater than or equal to the first threshold but is less than the second threshold, and a power at which the camera operates in the medium-electric quantity mode to be a second power; and
control the camera to work in a low-electric quantity mode if the electric quantity value is less than the first threshold, and a power at which the camera operates in the low-electric quantity mode to be a third power;
wherein the first power is greater than the second power, and the second power is greater than the third power.

13. The camera according to claim 12, wherein the at least one processor further executes the instructions to cause the camera to:
generate a video recording interface and display same on an electronic device being communicatively connected to the camera;
display a first icon for setting the first threshold and a second icon for setting the second threshold on the video recording interface, wherein the first icon and the second icon are used for sliding in a preset area, and different positions of the first icon and the second icon in the preset area correspond to different electric quantity values; and
display one first text corresponding to the first icon and one second text corresponding to the second icon on the video recording interface, wherein the contents displayed by the first text and the second text are respectively electric quantity values corresponding to positions where the first icon and the second icon are located.

14. The camera according to claim 13, wherein the at least one processor further executes the instructions to cause the camera to:
acquire a first electric quantity value corresponding to the position where the first icon is located in the preset area;
store the first electric quantity value as the first threshold in the memory of the camera;
acquire a second electric quantity value corresponding to the position where the second icon is located in the preset area; and
store the second electric quantity value as the second threshold in the memory of the camera.

15. The camera according to claim 12, wherein the camera further comprises an image capture unit, a fill light and a sensing unit, and the at least one processor further executes the instructions to cause the camera to:
when the camera works in the high-electric quantity mode, adjust the luminous power of a fill light to a first luminous power W₁, and control the image capture unit to perform video recording at a first video recording frame rate F₁, wherein 0<F₁≤Fₘₐₓ, and 0<W₁≤Wₘₐₓ, herein Fₘₐₓ is a maximum video recording frame rate of the image capture unit, and Wₘₐₓ is a maximum luminous power of the fill light;
when the camera works in the medium-electric quantity mode, adjust the luminous power of the fill light to a second luminous power W₂, and control an image capture unit of the camera to perform video recording at a second video recording frame rate F₂, wherein 0<F₂<F₁ and 0<W₂<W₁.

16. The camera according to claim 15, wherein the at least one processor further executes the instructions to cause the camera to:
in response to the sensing unit detecting presence of an intruding target in a monitored area, adjust the luminous power of the fill light to a third luminous power W₃, and control the image capture unit to perform video recording at a third video recording frame rate F₃, wherein 0<F₂<F₃≤Fₘₐₓ, and 0<W₂<W₃≤Wₘₐₓ;
in response to an operation of previewing the recorded video, adjusting the luminous power of the fill light to the third luminous power W₃, and controlling the image capture unit to perform video recording at the third video recording frame rate F₃; and
in response to the sensing unit detecting the intruding target leaving the monitored area, or ending the operation of previewing the recorded video, controlling the mode of the camera to switch back to the medium-electric quantity mode.

17. The camera according to claim 12, wherein the camera further comprises an image capture unit, a fill light and a sensing unit, and the at least one processor further executes the instructions to cause the camera to:
control the camera to enter a standby state when the camera works in the low-electric quantity mode, and control the sensing unit is in an operating state when the camera is in the standby state;
in response to the sensing unit detecting the presence of the intruding target in a monitored area, adjust the luminous power of the fill light to a third luminous power W₃, and control the image capture unit to perform video recording at a third video recording frame rate F₃, wherein 0<F₃≤Fₘₐₓ, and 0<W₃≤Wₘₐₓ, here Fₘₐₓ is a maximum video recording frame rate of the image capture unit, and Wₘₐₓ is a maximum luminous power of the fill light;
in response to an operation of previewing the recorded video, adjust the luminous power of the fill light to the third luminous power W₃, and control the image capture unit to perform video recording at the third video recording frame rate F₃; and
in response to the sensing unit detecting the intruding target leaving the monitoring area or ending the operation of previewing the recorded video, control the operating state of the camera to switch back to the standby state.

18. The camera according to claim 17, wherein the camera further comprises an AI detection unit, and the at least one processor further executes the instructions to cause the camera to:
in response to the sensing unit detecting the presence of the intruding target in the monitored area, control the AI detection unit to acquire a current image acquired at a current time of the image capture unit, and performing intruding target identification on the current image; and
adjust the luminous power of the fill light to the third luminous power W₃ and control the image capture unit to perform video recording at the third video recording frame rate F₃, when the AI detection unit identifies the intruding target from the current image;
control the AI detection unit to parse the recorded video recorded if the electric quantity value is greater than or equal to the second threshold; and
turn off the AI detection unit if the electric quantity value is less than the second threshold.

19. The camera according to claim 12, wherein the camera further comprises an image capture unit, a fill light and a sensing unit, and the at least one processor further executes the instructions to cause the camera to:
determine whether a current time is within a preset timed video recording period;
determine whether the camera is configured in a power-saving mode when the current time is within the timed video recording period;
if the camera is configured in the power-saving mode, acquire the electric quantity value of the camera; or if the camera is not configured in the power-saving mode, adjust the luminous power of the fill light to the maximum luminous power Wₘₐₓ, and control the image capture unit to perform video recording at the maximum video recording frame rate Fₘₐₓ;
control the camera to enter the standby state when the current time is not within the timed video recording period, and in response to the sensing unit detecting the presence of an intruding target or previewing the recorded video in a monitored area, adjust the luminous power of the fill light to a third luminous power W₃, and control the image capture unit to perform video recording at a third video recording frame rate F₃, wherein 0<F₃≤Fₘₐₓ, and 0<W₃≤Wₘₐₓ, here Fₘₐₓ is a maximum video recording frame rate of the image capture unit, and Wₘₐₓ is a maximum luminous power of the fill light; and
control the camera to enter the standby state in response to the sensing unit detecting the intruding target leaving the monitored area or ending the operation of previewing the recorded video.

20. A non-transitory computer-readable storage medium having a plurality of executable instructions stored thereon, wherein the executable instructions, when executed by at least one processor of a camera, cause the camera to:
acquire an electric quantity value of the camera;
determine a magnitude relationship between the electric quantity value and a first threshold, and the magnitude relationship between the electric quantity value and a second threshold, wherein the second threshold is greater than the first threshold;
control the camera to work in a high-electric quantity mode if the electric quantity value is greater or equal to the second threshold, and a power at which the camera operates in the high-electric quantity mode to be the first power;
control the camera to work in a medium-electric quantity mode if the electric quantity value is greater or equal to the first threshold but is less than the second threshold, and a power at which the camera operates in the medium-electric quantity mode to be a second power; and
control the camera to work in a low-electric quantity mode if the electric quantity value is less than the first threshold, and a power at which the camera operates in the low-electric quantity mode to be a third power;
wherein the first power is greater than the second power, and the second power is greater than the third power.
